(19) United States
(12) Patent Application Publication
(10) Pub. No.: US 2023/0306331 A1
(43) Pub. Date: Sep. 28, 2023

(54) AUTOMATIC MACHINE ASSEMBLY GUIDANCE

(71) Applicant: International Business Machines Corporation, Armonk, NY (US)

(72) Inventors: Venkata Vara Prasad Karri, Visakhapatnam (IN); Sarbajit K. Rakshit, Kolkata (IN); Shailendra Moyal, Pune (IN); Bhavya Pochiraju, Hyderabad (IN)

(21) Appl. No.: 17/656,229

(22) Filed: Mar. 24, 2022

(51) Int. Cl. G06Q 10/06; G06Q 10/08

(52) U.S. Cl. CPC G06Q 10/06315; G06Q 10/087

(57) ABSTRACT

A processor may receive component data associated with the machine. The component data may be associated one or more machine auxiliary components configured within one or more environments. The processor may generate a digital twin associated with the machine. The digital twin associated with the machine area may be based, at least in part, on the component data. The processor may simulate the digital twin of the machine. The processor may generate, responsive to simulating the digital twin associated with the machine, the optimized assembly plan for the machine.

### BACKGROUND

Aspects of the present disclosure relate generally to the field of artificial intelligence, and more particularly to optimizing inventory based on simulations.

As demand for certain products increases, so do the problems associated with maintaining a sufficient amount of available products. Ensuring a sufficient amount of available products are available enables business and factories to perform production functions in an efficient manner.

### SUMMARY

Embodiments of the present disclosure include a method, computer program product, and system for managing the assembly of a machine. A processor may receive component data associated with the machine. The component data may be associated one or more machine auxiliary components configured within one or more environments. The processor may generate a digital twin associated with the machine. The digital twin associated with the machine area may be based, at least in part, on the component data. The processor may simulate the digital twin of the machine. The processor may generate, responsive to simulating the digital twin associated with the machine, the optimized assembly plan for the machine.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 illustrates a block diagram of an example assembly management system, in accordance with aspects of the present disclosure.

FIG. 2 illustrates a flowchart of an example method for managing the assembly of a machine, in accordance with aspects of the present disclosure.

FIG. 3A illustrates a cloud computing environment, in accordance with aspects of the present disclosure.

FIG. 3B illustrates abstraction model layers, in accordance with aspects of the present disclosure.

FIG. 4 illustrates a high-level block diagram of an example computer system that may be used in implementing one or more of the methods, tools, and modules, and any related functions, described herein, in accordance with aspects of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Aspects of the present disclosure relate generally to the field of artificial intelligence, and more particularly to optimizing inventory (e.g., available products) based on simulations. While the present disclosure is not necessarily limited to such applications, various aspects of the disclosure may be appreciated through a discussion of various examples using this context.

Machines, particularly large machines such as those used in oil extraction facilities, may sometimes require specialized parts or components. When such parts or components fail, spare parts (e.g., machine auxiliary components) are often used to replace the broken components. Due to the nature of such facilities, spare parts may be manufactured, stored, and assembled, via fabrication units (e.g., manufacturing facilities), storage units (e.g., warehouse), and assembly units (e.g., location where spare parts may be assembled), in locations or environments that are different from the facility or location they will ultimately be used in. In some situations, the distance between various fabrication units, storage units, and assembly units may be substantial (e.g., fabrication unit is on a different continent than the assembly unit). In these situations, the transpiration of the spare parts from the fabrication units to the storage units, and then again from the storage units to the assembly units may result in significant time and cost to the company, particularly if the facility is down until a spare part arrives that will replace a failed component.

In situations where inventory is stored in various storage units, transportation vehicles are transporting the spare part inventory from different storage units or facilities (e.g., retail store, oil extraction facility, etc.). In these situations, if the proposed transportation route is not selected or the proper storage unit is not selected while transporting spare part inventory, then the transportation cost associated with the aggregated spare part inventory may be increased as the spare parts are transported between disparate locations (e.g., transportation from fabrication unity to storage unit). As such there is a desire to generate an optimized assembly plan for a machine that may require the use of machine auxiliary parts (e.g., spare parts or components), that provides an appropriate supply chain route and minimizes the cost of carrying an aggregated inventory.

Before turning to the FIGS. it is noted that the benefits/novelties and intricacies of the proposed solution are that:

An assembly management system may be configured to simulate assembling capacity of various assembling machines in any assembling unit. Based on the simulated results, the assembly management system may be configured to identify how many finished or simi-finished products can be assembled within a particular duration of time. In some embodiments, the assembly management system (e.g., via the optimized assembly plan) may be configured to recommend the appropriate amount of auxiliary machine components that should be maintained within various storage units. In some embodiments, the assembly management system may further recommend particular transportation or delivery plans associated with the auxiliary machine components to different assembling units.

The assembly management system may be configured to generate one or more digital twins based on component data. Using this aforementioned data, assembly management system may generate one or more simulations associated with the assembling capacity of various assembling machines in one or more assembly units. Using such simulations, the assembly management system may identify appropriate storage unit locations that may minimize the cost associated with the transportation of auxiliary machine components. For example, this may allow for an optimized type of and number of auxiliary machine components to be collected and transported to various assembly units in an optimized manner that minimizes inventory carrying costs and transportation costs.

The assembly management system may be configured to identify real-time amount of auxiliary machine components configured within any storage unit and identify the different types of auxiliary machine components in each storage unit. In some embodiments, assembly management system may be configured to identify a new assembly unit. In these embodiments, the new assembly unit may be an environment with a location that minimizes transportation and inventory carrying costs.

The assembly management system may be configured to use digital twin technology to generate simulations associated with fabrication units, storage units, and assembly units. The assembly management system may be configured to identify if the speed at which various auxiliary machine components are manufactured should be reduced or increased based on demand. For example, assembly management system may generate one or more recommendations (e.g., via optimized assembly plan) how much a fabrication unit should decrease fabrication to ensure the aggregated inventory carrying cost is sufficiently minimized.

The assembly management system may be configured to simulate the transportation costs associated with the various auxiliary machine components, the inventory carry cost, and the fabrication unit's capacity to manufacture such auxiliary machine components over a particular duration of time. Using the information generated from such simulations, assembly management system may identify how various transportation vehicles should be loaded. Such information may be used to minimize the number of trips the transportation vehicles may need to make between fabrication units, storage units, and assembly units.

The assembly management system may be configured to simulate for unique situations and different contexts. For example, assembly management system may collect information (e.g., component data) associated with changes in fuel costs and changes in population (e.g., based on festivals and changes in season). The assembly management system may then use this information to generate the optimized assembly plan that proactively plans for the transportation of auxiliary machine components.

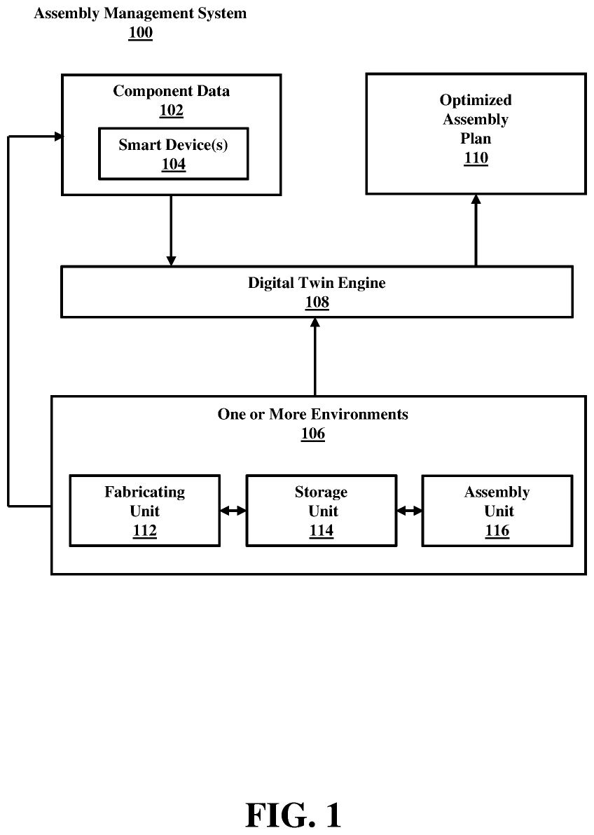

Referring now to FIG. 1, illustrated is a block diagram of an example assembly management system 100, in accordance with aspects of the present disclosure for generating an optimized assembly plan for repairing or replacing a machine. FIG. 1 provides an illustration of only one implementation and does not imply any limitations with regard to the environments in which different embodiments may be implemented. Many modifications to the depicted environment may be made by those skilled in the art without departing from the scope of the invention as recited by the claims.

As depicted in FIG. 1, assembly management system 100 may be configured to include, component data 102, one or more smart device(s) 104, one or more environment(s) 106, digital twin engine 108, and optimized assembly plan 110. As contemplated herein, machines may be used in a variety of facilities or factories to perform various processes that may be necessary for the factory to produce their product or main function. For example, in some situations, machines may be used in such a way that if a machine fails or breaks down (e.g., one or more machine components fail), the entire factory or facility may come to a standstill. In these situations, the factory may be unable to perform necessary functions (e.g., product production) and may cost the factory a substantial amount as a result of the downtime. As such, factories may have spare or auxiliary machine components in one or more storage units (e.g., one or more environments) that may, depending on the machine, be able to replace the failed broken component of the machine.

In embodiments, assembly management system 100 may be configured to utilize component data 102 associated with a machine. A machine may include any device that may be used to perform some function. While embodiments contemplated herein often refer to large and sometimes complex machines, such embodiment should not be construed to be limiting and are only indented as a set of examples. Machines contemplated herein may be configured of any number of machine components. These machine components may fail over time as the machine is used.

In embodiments, component data 102 may include any data/information associated with the machine and the machine's various machine components and auxiliary machine components (e.g., replacement machine components). For example, component data 102 may include, but is not limited to, i) information associated with each individual machine component (e.g., specification of machine component), ii) how the machine component performs overtime under different conditions (e.g., high workload, under high temperatures, etc.), iii) what types of machine auxiliary component may be used to replace a failed machine component, iv) where the auxiliary machine components may be manufactured or procured from (e.g., fabrication unit 112), v) the time associated with manufacturing/fabricating the various auxiliary machine components, vi) where the auxiliary machine components may be stored (e.g., storage unit 114), vii) the amount of time and/or distance will it take to transport the auxiliary machine components to various locations (e.g., between the storage unit 114 and assembly unit 116), viii) information associated with how to assemble the auxiliary machine components and/or how to replace the machine or the one or more failed machined components with the one or more auxiliary machine components, and ix) any data/information generated as a result of any analyses and/or simulations contemplated herein.

In embodiments, assembly management system 100 may be configured to collect/receive component information. While in some embodiments, assembly management system 100 may be configured to receive component information from one or more databases, in other embodiments, assembly management system 100 may be configured to receive component data from one or more smart devices 104. Smart devices 104 may be any device, such as Internet of Things (IoT) devices and sensors, that may be configured to collect information in real-time. In some embodiments, one or more smart devices 104 may be configured within or surrounding the machine. In such embodiments, the one or more smart devices 104 may be configured to collect component data associated with how the machine functions and information associated with the machine components.

In embodiments, one or more auxiliary machine components may be associated with one or more environments 106 prior to being utilized by the machine. These one or more environments 106 may include a fabrication unit 112, a storage unit 114, and an assembly unit 116. Fabrication unit 112 may refer to an environment or location where an auxiliary machine component may be fabricated or altered. Storage units 114 may refer an environment or location where an auxiliary machine component may be stored after fabrication (e.g., as inventory) until the auxiliary machine components are needed (e.g., needed to replace or repair a machine). Assembly unit 116 may refer to an environment or location where one or more auxiliary machine components may be assembled together. In some embodiments, multiple auxiliary machine components may be required to be assembled to replace or repair a machine. In some embodiments, it may be more cost effective to transport the multiple auxiliary components to a single location (e.g., assembly unit 116) to be assembled instead of individually transporting each of the auxiliary machine components to the machine location. In some embodiments, assembly unit 116 may be the same location where the machine is located. In some embodiments, though fabrication unit 112, a storage unit 114, and an assembly unit 116 may be separate environments, in other embodiments, one or more of these environments may be combined into a single environment. For example, the fabrication unit 112 and the storage unit 114 may be configured within the same location or environment. In embodiments, one or more smart devices 104 may be configured within one or more environments 106 to collect component data associated with each of the environments.

In embodiments, assembly management system 100 may configure digital twin engine 108 to generate one or more digital twins associated with the machine (e.g., using artificial intelligence and machine learning capabilities). The assembly management system 100 may base the one or more digital twins on component data. Assembly management system 100, using digital twin engine 108, may generate one or more simulations. Using these one or more simulations, assembly management system 100 may be configured to generate an optimized assembly plan 110 associated with the machine and the one or more auxiliary machine components. Optimized assembly plan 110 may be configured to contain any information contemplated herein associated with the one or more digital twins and/or simulations generated by assembly management system 100 (e.g., via digital twin engine 108).

The simulations and resulting information provided in optimized assembly plan 110 may include a variety of information. In some embodiments, assembly management system 100 may simulate a digital twin of the machine to determine not only the capacity of the machine itself, but also the capacity or possible load each of the machine components are capable of. Assembly management system 100 may also identify how the machine's capacity may be impacted over time (e.g., reduced capacity). In these embodiments, assembly management system 100 may be configured to predict how when one or more machine components may fail. In some embodiments, assembly management system may configure the digital twin to simulate (e.g., via digital twin engine 106) to determine how many machine components and/or auxiliary machine components can be assembled or partially assembled during a particular duration of time.

In embodiments, assembly management system 100 may be configured to identifying an inventory plan (e.g., product plan). In some embodiments, this inventory plan may be provided to a user as a component of optimized assembly plan 110. Assembly management system 100 may base the inventory plan may be based at least in part on a simulation of the digital twin using component data may identify a minimum recommended or optimized amount of the one or more machine auxiliary components that should be manufactured and stored (e.g., via fabrication unit 112 and storage unit 114). For example, assembly management system 100 may analyze component data associated with the available storage unit space, cost to maintain the storage space, and time associated with manufacturing/fabricating a new auxiliary machine component, to generate a digital twin and determine the most cost effective amount of auxiliary machine components should be stored within an environment 106 (e.g., storage unit 114).

In embodiments, assembly management system 100 may be configured to simulate one or more digital twins (e.g., via digital twin engine 108) to determine the assembly time. The assembly time may refer to the amount of time for it would take to replace or repair the machine with the auxiliary machine component. This may include identifying the amount of time it may take to manufacture the auxiliary machine component, how long to transport the auxiliary machine component from one environment to the next, how long it takes to assemble the auxiliary machine components, once the one or more auxiliary machine components are collected, and/or how long it takes to repair or replace the machine with the auxiliary machine component.

In embodiments, assembly management system 100 may be configured to analyze component data and identify a transportation dataset. In embodiments, the transportation dataset may include data/information associated with transporting the one or more machine auxiliary components from the one or more environments to an assembly unit. In some embodiments, one or more smart devices 104 may be configured within one or more transportation vehicles (e.g., vehicles used to transport auxiliary machine components) to collect the transportation dataset in real-time and relay it to digital twin engine 106 to use while simulating. Using this data, assembly management system 100 may be configured to identify one or more transportation routes between the one or more environments. In one example embodiment, assembly management system may receive a transportation dataset (e.g., component data) associated with various routes possible travel routes between the fabrication unit 112, storage unit 114, and assembly unit. In this example embodiment, there may be multiple auxiliary machine components stored within different storage units 114. Assembly management system may use the transportation dataset to determine the most concise and/or cost effective route between various environments 106. stored (e.g., inventory plan/product plan of the optimized assembly plan 106). In some embodiments, assembly management system 100 may be configured to generate a digital twin of the one or more auxiliary machine components and simulate how particular transportation vehicles should be loaded to optimize the number of trips between the one or more environments and reduce costs.

In some embodiments, assembly management system 100 may further analyze the assembly time to determine if there are one or more optimized environments. An optimized environment may include a new location for a fabrication unit, storage unit, and/or assembly unit that is located or configured in such a way that minimizes the cost or time associated with assembly (e.g., repairing/replacing the machine with auxiliary machine components). In one example embodiment, assembly management system 100 may be configured to determine (e.g., using component data) the location of a fabrication unit, storage unit, and assembly unit. In this example, assembly management system 100 may be configured to identify that while the fabrication unit and assembly unit are located in City A, the storage unit housing the auxiliary machine components is located 100 miles away in City B. As such, assembly management system 100 may determine the assembly time associated with this configuration. Assembly management system 100 may perform additional simulations and determine that the cost and time associated with transporting the auxiliary machine component may be significantly reduced by moving the storage unit located in City B closer to City A. As such, assembly management system 100 may configure the optimized assembly plan 110 to include an improved or optimized location for each of the one or more environments 106 (e.g., an optimized fabrication unit, an optimized storage unit, or an optimized assembling unit). In some embodiments, assembly management system 100 may be configured to identify the capacity of each of the one or more environment (e.g., how many auxiliary machine components may be stored in a particular storage unit 114).

In embodiments, as contemplated herein, assembly management system 100 may also use one or more digital twins to simulate and identify what the minimum amount and type of auxiliary machine components should be stored within storage units 114 at any particular time. Assembly management system 100 may also determine the time it takes for the minimum inventory amount to be reduced within storage units 114 as well as determine how quickly a fabrication unit 112 may need to replace a particular type of auxiliary machine component. In some embodiments, based on the aforementioned simulations, assembly management system 100 may be configured to send the one or more environments 106 notifications that a change should take place. For example, when inventory of a particular type of auxiliary machine component is low in storage unit 114, assembly management system 100 may be configured to issue a notification to a fabrication unit 112 to begin manufacturing/fabricating of the particular type of auxiliary machine component. Alternatively, when inventory of a particular type of auxiliary machine component is too high and exceeds the minimum determined inventory amount (e.g., inventory plan) in storage unit 114, assembly management system 100 may be configured to issue a notification to a fabrication unit 112 to reduce or stop manufacturing/fabricating of the particular type of auxiliary machine component.

In some embodiments, in addition to the aforementioned simulation related information, optimized assembly plan 110 may also be configured to include information such as the aggregated transportation cost, the inventory carrying cost associated with maintaining and as repairing/replacing the one or more auxiliary machine components. In addition, assembly management system 100 may use digital twin engine 108 to simulate how the aggregate transportation costs and various costs associated with maintaining a minimum number of auxiliary components while also ensuring the machine breakdown time is minimized. This information/data may be provided to a user in optimized assembly plan 110.

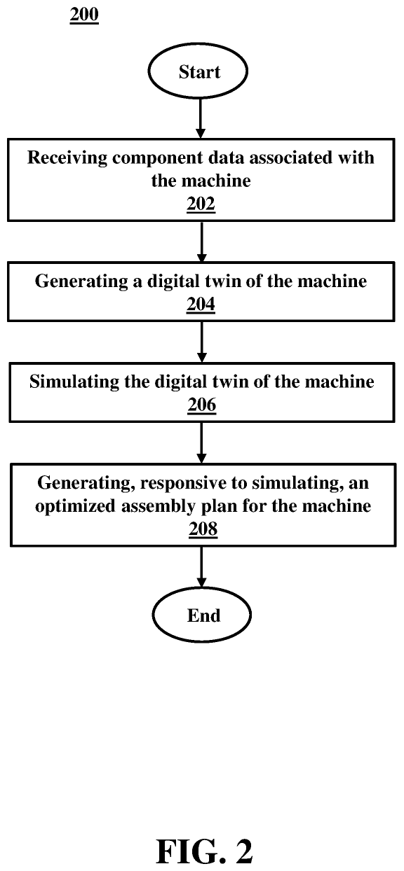

Referring now to FIG. 2, a flowchart illustrating an example method 200 for managing the assembly of a machine, in accordance with embodiments of the present disclosure. FIG. 2 provides an illustration of only one implementation and does not imply any limitations with regard to the environments in which different embodiments may be implemented. Many modifications to the depicted environment may be made by those skilled in the art without departing from the scope of the invention as recited by the claims.

In some embodiments, the method 200 begins at operation 202 where a processor may receive component data associated with a machine. In some embodiments, the component data may be associated with one or more machine auxiliary components configured within one or more environments. In some embodiments, the method 200 proceeds to operation 204.

At operation 204, a processor may generate a digital twin associated with the machine. In some embodiments, the digital twin associated with the machine area may be based, at least in part, on component data. In some embodiments, the method 200 proceeds to operation 206.

At operation 206, a processor may simulate the digital twin associated with the machine. In some embodiments, the method 200 proceeds to operation 208.

At operation 208, a processor may generate, responsive to simulating the digital twin associated with the machine, the optimized assembly plan for the machine. In some embodiments, the optimized assembly plan may include an assembly time. The assembly time may be the total amount of time needed to assemble the one or more machine auxiliary components into the machine. In some embodiments, as depicted in FIG. 2, after operation 208, the method 200 may end.

In some embodiments, discussed below, there are one or more operations of the method 200 not depicted for the sake of brevity and which are discussed throughout this disclosure. Accordingly, in some embodiments, the processor may identify an inventory plan (e.g., product plan). The inventory plan may be based, at least in part on the digital twin of the machine. In some embodiments, the inventory plan may include a minimum recommended amount of the one or more machine auxiliary components.

In some embodiments, the optimized assembly plan may include a transportation dataset. The transportation dataset may be associated with transporting of the one or more machine auxiliary components from the one or more environments to an assembly unit.

In some embodiments, the processor may analyze the component data associated with each of the one or more environments. In these embodiments, the processor may determine whether the one or more environments are a fabrication unit, a storage unit, and/or an assembly unit.

In some embodiments, the processor may identify one or more transportation routes. These transportation routes may be associated with the fabrication unit, the storage unit, and the assembly unit.

In some embodiments, the processor may identify an optimized fabrication unit, an optimized storage unit, or an optimized assembly unit.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of portion independence in that the consumer generally has no control or knowledge over the exact portion of the provided resources but may be able to specify portion at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

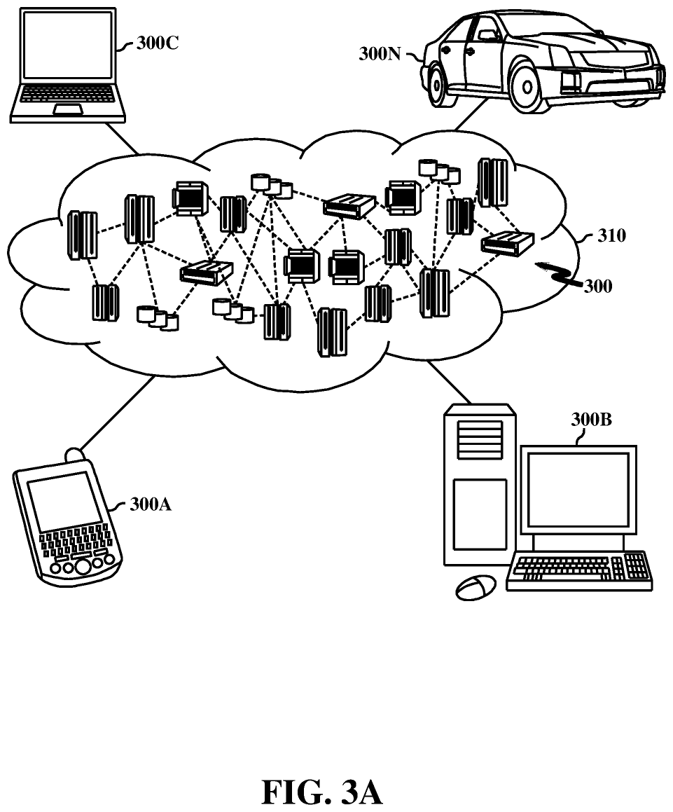

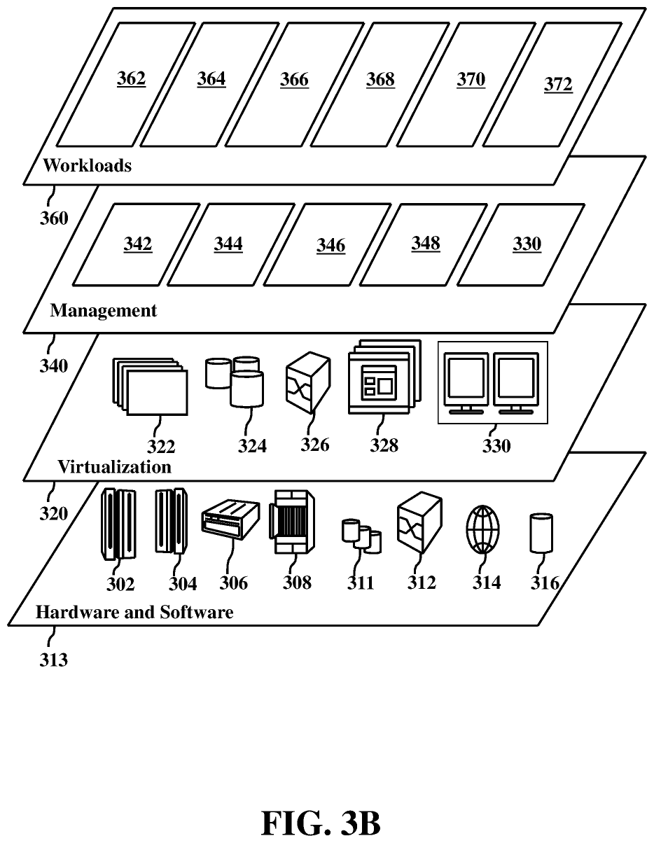

FIG. 3A, illustrated is a cloud computing environment 310 is depicted. As shown, cloud computing environment 310 includes one or more cloud computing nodes 300 with which local computing devices used by cloud consumers, such as, for example, personal digital assistant (PDA) or cellular telephone 300A, desktop computer 300B, laptop computer 300C, and/or automobile computer system 300N may communicate. Nodes 300 may communicate with one another. They may be grouped (not shown) physically or virtually, in one or more networks, such as Private, Community, Public, or Hybrid clouds as described hereinabove, or a combination thereof.

This allows cloud computing environment 310 to offer infrastructure, platforms and/or software as services for which a cloud consumer does not need to maintain resources on a local computing device. It is understood that the types of computing devices 300A-N shown in FIG. 3A are intended to be illustrative only and that computing nodes 300 and cloud computing environment 310 can communicate with any type of computerized device over any type of network and/or network addressable connection (e.g., using a web browser).

FIG. 3B, illustrated is a set of functional abstraction layers provided by cloud computing environment 310 (FIG. 3A) is shown. It should be understood in advance that the components, layers, and functions shown in FIG. 3B are intended to be illustrative only and embodiments of the disclosure are not limited thereto. As depicted below, the following layers and corresponding functions are provided.

Hardware and software layer 315 includes hardware and software components. Examples of hardware components include: mainframes 302; RISC (Reduced Instruction Set Computer) architecture based servers 304; servers 306; blade servers 308; storage devices 311; and networks and networking components 312. In some embodiments, software components include network application server software 314 and database software 316.

Virtualization layer 320 provides an abstraction layer from which the following examples of virtual entities may be provided: virtual servers 322; virtual storage 324; virtual networks 326, including virtual private networks; virtual applications and operating systems 328; and virtual clients 330.

In one example, management layer 340 may provide the functions described below. Resource provisioning 342 provides dynamic procurement of computing resources and other resources that are utilized to perform tasks within the cloud computing environment. Metering and Pricing 344 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 346 provides access to the cloud computing environment for consumers and system administrators. Service level management 348 provides cloud computing resource allocation and management such that required service levels are met. Service Level Agreement (SLA) planning and fulfillment 350 provide pre-arrangement for, and procurement of, cloud computing resources for which a future requirement is anticipated in accordance with an SLA.

Workloads layer 360 provides examples of functionality for which the cloud computing environment may be utilized. Examples of workloads and functions which may be provided from this layer include: mapping and navigation 362; software development and lifecycle management 364; virtual classroom education delivery 366; data analytics processing 368; transaction processing 370; and optimized assembly management 372.

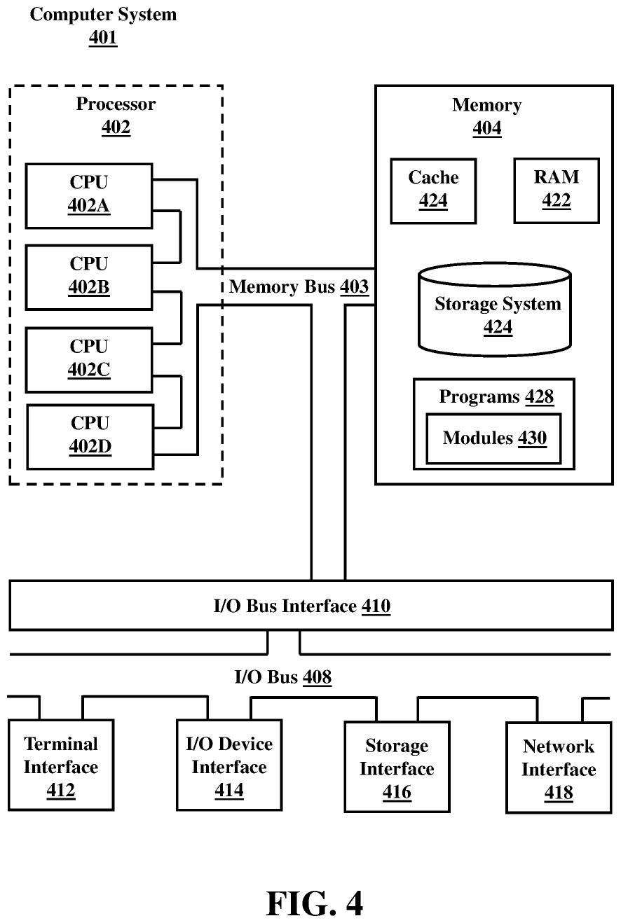

FIG. 4, illustrated is a high-level block diagram of an example computer system 401 that may be used in implementing one or more of the methods, tools, and modules, and any related functions, described herein (e.g., using one or more processor circuits or computer processors of the computer), in accordance with embodiments of the present disclosure. In some embodiments, the major components of the computer system 401 may comprise one or more CPUs 402, a memory subsystem 404, a terminal interface 412, a storage interface 416, an I/O (Input/Output) device interface 414, and a network interface 418, all of which may be communicatively coupled, directly or indirectly, for inter-component communication via a memory bus 403, an I/O bus 408, and an I/O bus interface unit 410.

The computer system 401 may contain one or more general-purpose programmable central processing units (CPUs) 402A, 402B, 402C, and 402D, herein generically referred to as the CPU 402. In some embodiments, the computer system 401 may contain multiple processors typical of a relatively large system; however, in other embodiments the computer system 401 may alternatively be a single CPU system. Each CPU 402 may execute instructions stored in the memory subsystem 404 and may include one or more levels of on-board cache.

System memory 404 may include computer system readable media in the form of volatile memory, such as random access memory (RAM) 422 or cache memory 424. Computer system 401 may further include other removable/non-removable, volatile/non-volatile computer system storage media. By way of example only, storage system 426 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, memory 404 can include flash memory, e.g., a flash memory stick drive or a flash drive. Memory devices can be connected to memory bus 403 by one or more data media interfaces. The memory 404 may include at least one program product having a set (e.g., at least one) of program modules that are configured to carry out the functions of various embodiments.

One or more programs/utilities 428, each having at least one set of program modules 430 may be stored in memory 404. The programs/utilities 428 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Programs 428 and/or program modules 430 generally perform the functions or methodologies of various embodiments.

Although the memory bus 403 is shown in FIG. 4 as a single bus structure providing a direct communication path among the CPUs 402, the memory subsystem 404, and the I/O bus interface 410, the memory bus 403 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 410 and the I/O bus 408 are shown as single respective units, the computer system 401 may, in some embodiments, contain multiple I/O bus interface units 410, multiple I/O buses 408, or both. Further, while multiple I/O interface units are shown, which separate the I/O bus 408 from various communications paths running to the various I/O devices, in other embodiments some or all of the I/O devices may be connected directly to one or more system I/O buses.

In some embodiments, the computer system 401 may be a multi-user mainframe computer system, a single-user system, or a server computer or similar device that has little or no direct user interface, but receives requests from other computer systems (clients). Further, in some embodiments, the computer system 401 may be implemented as a desktop computer, portable computer, laptop or notebook computer, tablet computer, pocket computer, telephone, smartphone, network switches or routers, or any other appropriate type of electronic device.

It is noted that FIG. 4 is intended to depict the representative major components of an exemplary computer system 401. In some embodiments, however, individual components may have greater or lesser complexity than as represented in FIG. 4, components other than or in addition to those shown in FIG. 4 may be present, and the number, type, and configuration of such components may vary.

As discussed in more detail herein, it is contemplated that some or all of the operations of some of the embodiments of methods described herein may be performed in alternative orders or may not be performed at all; furthermore, multiple operations may occur at the same time or as an internal part of a larger process.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

What is claimed is:

1. A computer implemented method for generating an optimized assembly plan for a machine, the method comprising:
receiving, by a processor, component data associated with the machine, wherein the component data is associated one or more machine auxiliary components configured within one or more environments;
generating a digital twin associated with the machine, wherein the digital twin associated with the machine area is based, at least in part, on the component data;
simulating the digital twin associated with the machine; and
generating, responsive to simulating the digital twin associated with the machine, the optimized assembly plan for the machine.

2. The method of claim 1, further comprises:
identifying an product plan based, at least in part on the digital twin of the machine wherein the product plan includes a minimum recommended amount of the one or more machine auxiliary components.

3. The method of claim 1, wherein the optimized assembly plan includes an assembly time, wherein the assembly time is a total amount of time needed to assemble the one or more machine auxiliary components into the machine.

4. The method of claim 1, wherein the optimized assembly plan includes a transportation dataset, wherein the transportation dataset is associated with transporting of the one or more machine auxiliary components from the one or more environments to an assembly unit.

5. The method of claim 1, further comprising:
analyzing the component data associated with each of the one or more environments; and
determining whether the one or more environments are a fabrication unit, a storage unit, or an assembly unit.

6. The method of claim 5, further including:
identifying one or more transportation routes associated with the fabrication unit, the storage unit, and the assembly unit.

7. The method of claim 5, further including:
identifying an optimized fabrication unit, an optimized storage unit, or an optimized assembly unit.

8. A system for generating an optimized assembly plan for a machine, the system comprising:
a memory; and
a processor in communication with the memory, the processor being configured to perform operations comprising:
receiving component data associated with the machine, wherein the component data is associated one or more machine auxiliary components configured within one or more environments;
generating a digital twin associated with the machine, wherein the digital twin associated with the machine area is based, at least in part, on the component data;
simulating the digital twin associated with the machine; and
generating, responsive to simulating the digital twin associated with the machine, the optimized assembly plan for the machine.

9. The system of claim 8, further comprises:
identifying an product plan based, at least in part on the digital twin of the machine wherein the product plan includes a minimum recommended amount of the one or more machine auxiliary components.

10. The system of claim 8, wherein the optimized assembly plan includes an assembly time, wherein the assembly time is a total amount of time needed to assemble the one or more machine auxiliary components into the machine.

11. The system of claim 8, wherein the optimized assembly plan includes a transportation dataset, wherein the transportation dataset is associated with transporting of the one or more machine auxiliary components from the one or more environments to an assembly unit.

12. The system of claim 8, further comprising:
analyzing the component data associated with each of the one or more environments; and
determining whether the one or more environments are a fabrication unit, a storage unit, or an assembly unit.

13. The system of claim 12, further including:
identifying one or more transportation routes associated with the fabrication unit, the storage unit, and the assembly unit.

14. The system of claim 12, further including:
identifying an optimized fabrication unit, an optimized storage unit, or an optimized assembly unit.

15. A computer program product for generating an optimized assembly plan for a machine, comprising a computer readable storage medium having program instructions embodied therewith, the program instructions executable by a processor to cause the processor to perform operations, the operations comprising:
receiving component data associated with the machine, wherein the component data is associated one or more machine auxiliary components configured within one or more environments;
generating a digital twin associated with the machine, wherein the digital twin associated with the machine area is based, at least in part, on the component data;
simulating the digital twin associated with the machine; and
generating, responsive to simulating the digital twin associated with the machine, the optimized assembly plan for the machine.

16. The computer program product of claim 15, further comprises:
identifying an product plan based, at least in part on the digital twin of the machine wherein the product plan includes a minimum recommended amount of the one or more machine auxiliary components.

17. The computer program product of claim 15, wherein the optimized assembly plan includes an assembly time, wherein the assembly time is a total amount of time needed to assemble the one or more machine auxiliary components into the machine.

18. The computer program product of claim 15, wherein the optimized assembly plan includes a transportation dataset, wherein the transportation dataset is associated with transporting of the one or more machine auxiliary components from the one or more environments to an assembly unit.

19. The computer program product of claim 15, further comprising:
analyzing the component data associated with each of the one or more environments; and
determining whether the one or more environments are a fabrication unit, a storage unit, or an assembly unit.

20. The computer program product of claim 19, further including:
identifying one or more transportation routes associated with the fabrication unit, the storage unit, and the assembly unit.
